(19) United States
(12) Patent Application Publication
(10) Pub. No.: US 2012/0017487 A1
(43) Pub. Date: Jan. 26, 2012

(54) Universal Fishing Rod Support Device

(76) Inventor: William O'Keefe, Philadelphia, PA (US)

(21) Appl. No.: 13/185,616

(22) Filed: Jul. 19, 2011

Related U.S. Application Data
(60) Provisional application No. 61/367,016, filed on Jul. 23, 2010.

(51) Int. Cl. A01K 97/10

(52) U.S. Cl. 43/21.2

(57) ABSTRACT

A modular fishing rod support device comprising a plurality of mounting elements, rod supporting elements and elongated bar attachments for supporting rods of various length in a working position. The mounting elements comprise a permanently mountable embodiment for attachment to a larger structure, along with an easily removable clamp embodiment for temporarily mounting to an acceptable base structure. A foot pedal is provided for attachment to the clamping device, or for operation on its own, which comprises a triangular body member, rod stem and attachment means for providing support for a fishing rod handle at a defined angle. A rod angle mount provides support for a rod handle using a pin and slot configuration, attachable to a pedestal mounting element for positioning a rod at a predefined angle therefrom. Elongated bar attachments provide parallel support along the length of the fishing rod, while U-channel support elements along the bar and a rod butt holder provide sufficient rod stability for maintaining its position under load from an extended lure, high winds or from an engaged fish.

### CROSS REFERENCE TO RELATED APPLICATION

This application claims the benefit of U.S. Provisional Application No. 61/367,316 filed on Jul. 23, 2010, entitled “The Weofish Adjustable Rod Holder System.”

### BACKGROUND OF THE INVENTION

1. Field of the Invention

The present invention relates to a fishing support apparatus, and more specifically to a modular device for providing portable support and retention of a fishing pole in various configurations and situations.

2. Description of the Prior Art

It is common practice to incorporate the use of a fishing rod holder or similar device while fishing, particularly while fishing from a boat or sea fishing from the shore. Manually holding a rod can be tiresome after extended periods, where a rod holder may support a rod in a working position with a lure extended in the water indefinitely. Various rod holder devices have been disclosed in the art and are available for purchase. These devices have familiar design and structural elements; however they are not adapted for the task of providing a modular rod holding device that includes various configurations to suit different situations and rod types.

The present invention provides a device that incorporates several detail parts that combine into a larger assembly to form a universal rod holder that may be tailored to suit a user's preferences or a particular setup. The components can be categorized into three main components: a ground attachment, a rod handle support and an elongated bar support. The ground attachment devices include embodiments that allow for permanent mounting of the assembly to a larger support structure, or an embodiment that temporarily secures the assembly using a turn-screw clamp to removably attach the assembly to a particular support structure. Rod handle supports include several detail parts that provide support for the rod handle and the butt of the rod. These parts secure the base of the fishing rod and prevent rigid body movement or dislocation thereof. Finally, the elongated bar attachment devices comprise elongated bars that support the rod along its length based on various length support bars. U-channel support fittings are provided along the length of the rod supports, which may be further secured to the rod using hook and loop fastener strips. The exact dimensions and combination of the three main components can be varied to suit different rod types or different fishing setups. Together, they form a universal device that can provide support for several different types of fishing rods, and in several fishing scenarios to suit the user.

The prior art contains a variety of rod support devices that attempt to aid a fisherman while a lure is extended, eliminating the need to manually handle the rod prior to snagging a catch fish. These devices are generally designed for a singular purpose or situation, while the present invention provides a modular set of components that are interchangeable to fit the user's needs or preferences.

Gutierrez, U.S. Pat. No. 5,187,892 discloses a holder for a fishing rod that has a rearward rod handle support, a forward rod handle support and a frame upon which the supports are mounted. The forward rod handle support has a first and second finger mounted for pivotal movement of their tips in unison toward each other when a downward force is applied to a cable connecting the bottom end portions of the fingers. The fishing rod holder comprises an integral steel rod which includes two downwardly depending legs which can be slidingly received in any of a variety of supports. The holder may be mounted to a folding stand of the invention, the edge of a boat, or any other portable or fixed support device in a number of manners. The support means of Gutierrez are a rearward and forward strap that exert pressure in opposite directions. This patent does not disclose an elongated bar support or a similarly designed rod handle support device. The mounting means of Gutierrez similarly describes a base plate with permanent screws only, and not a removable clamp embodiment as described in the present invention.

Miller, U.S. Pat. No. 4,730,408 discloses a device which holds a fishing rod and automatically sets a fishhook in a fish. A stake driven into the ground supports a pivot arm on which the rod is held. A trip lever holds the arm in position for fishing and is released by a trigger wire when the fishing line is subjected to a pulling force caused by a strike on the bait. A spring then pivots the arm upwardly in an abrupt and forceful manner to set the fishhook. A stake is used to secure the device into turf. It does not include a foot pedal and clamping attachment means and is not adapted for use on boats, piers, or other above ground locations. Miller discloses a forward and rearward bracket means for securing a fishing pole to a support rod, but does not disclose a pole holding cup or hook and loop means for stabilizing a reel.

Duke, U.S. Pat. No. 4,650,146 discloses a support for at least one fishing rod at an appropriate angle for fishing to alleviate the need for the person fishing to hold the fishing rod. The device has a support rod having a stake at one end for driving into the ground. It does not disclose a clamp or adjustable means for attaching to a dock, boat or pier. Fishing rods are removably affixed to the support by two supporting rods with permanently affixed brackets. No rod holding cup or hook attachments are disclosed. The device is adjustable to allow the fisherman to adjust the direction of the rod or rods; however it does not include a foot pedal of adjustable pitch.

Miller, U.S. Pat. No. 4,407,089 discloses a support device for a fishing rod having a clamp means for attaching the device to a boat, a cylindrical rod holder adapted to receive and retain the end of a fishing rod, a bracket for removably securing the cylindrical rod holder. Miller does not disclose a means for adjusting the forward pitch of a fishing rod supported by the device. It does not disclose a variety of lengths of supporting arms for a rod holding cup to affix to. The cylindrical rod holder of Miller is not adjustable with respect to position along the device, like the rod holder cup of the present invention. Additionally Miller does not contemplate a foot pedal affixed to a support bar, the former being a means for securing the device to a securing clamp.

Roberts, U.S. Pat. No. 5,313,734 discloses a fishing rod holder including a holster portion for receiving a rod and a flexible clamp rotatably mounted in a recess on one end of the holster for retaining a reel within the holster. The holster includes support flanges extending therefrom and straddling the recess for supporting the clamp in the recess and for providing stops to the rotation of the clamp when locking a rod in the holster or when releasing the rod from the holster. The holster is used to retain a fishing rod rather than the supporting rod and removably attached rod holder cup of the present invention. Roberts does not disclose a foot pedal removably affixed to the clamp that operatively connects the fishing rod support to the clamp.

Whitfield et al., U.S. Pat. No. 3,835,568 discloses a fishing rod holder having means for signaling a stroke. The holder includes an upright support and an alarm box carried by the top of the upright support. Clamping means are carried by the top of an alarm box and a pair of opposed forward and reward U-shaped members, the legs of both of which are adjustably held by the clamping means, provide a rod and reel assembly support. A fishing rod is placed on a u-shaped recess in the front of the support, and the end of the rod is placed under an inverted u-shaped support. In this manner the fishing rod is kept in place, there is no disclose of supporting rods that are removably affixed to rod holding cups. Whitfield does not disclose a foot pedal operatively connecting the supporting means and clamping means.

Jershin, U.S. Pat. No. 4,541,196 discloses a fishing rod mounting device and electronic signaling device. The rod mounting device comprises an open topped rod support channel that attaches to the handle of the rod. The electronic signaling device provides an electrical circuit, a housing, a power source, and a switch that activates based on movement of the rod and the presence of a catch fish on the lure. This device provides a fishing rod mounting device and one that can alert a fisherman that a fish has struck the line. While novel and fulfilling a particular requirement, the structural aspects of the Jershin device differ from the disclosed invention. Although both are universal, the elements of the present invention differ in structure and spirit.

The present invention provides a device that can support an extended fishing rod from a variety of surfaces and support structures. Its construction allows support for nearly any type of fishing rod, and allows the user to place the rod onto the device for support thereof for extended periods of time. This eliminates the need for the user to manually handle the rod between castings. Its structure substantially diverges in design elements from the prior art, consequently it is clear that there is a need in the art for an improvement to the existing universal and modular fishing rod support devices. In this regard the instant invention substantially fulfills these needs.

### SUMMARY OF THE INVENTION

In view of the foregoing disadvantages inherent in the known types of universal and modular fishing rod support devices now present in the prior art, the present invention provides a new fishing rod support device wherein the same can be utilized for providing convenience for the user when supporting an extended fishing rod from a variety of support surfaces and structures, and accommodating a variety of different style fishing rods therefrom.

The present invention provides a ground attachment, a rod handle support and an elongated bar attachment for support a fishing rod in use. The ground attachment device employs either a permanently attached fixture or a removably attached clamping device to provide stability from and attachment to a larger structure. The structure may include a railing, a location on a boat, a dock or even the ground itself. Rod handle support devices are provided to support the butt of the fishing rod handle and provide U-shaped channels for the rod to bear against. Elongated bar attachments run the length of the fishing rod and may further be used to secure the assembly into a ground surface if desired. Hook and loop fastener straps may be utilized along the bar attachment to ensure the rod and rod support device stays intact during operation.

It is therefore an object of the present invention to provide a new and improved fishing rod support device that has all of the advantages of the prior art and none of the disadvantages.

Another object of the present invention is to provide a modular and universal fishing rod support device that allows a user to support a fishing rod from a variety of surfaces or structures without constant vigilance.

Yet another object of the present invention is to provide fishing rod support device that can be arranged in a number of different configurations to suit different style fishing rods and a variety of situations. The elements of the invention are interchangeable and modular to suit the given condition or the user's preference while supporting a fishing rod in use.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings, wherein like numeral annotations are referenced herein.

FIG. 1 shows a side perspective view of the permanently fixed ground attachment embodiment, holding a fishing rod in use.

FIG. 2 shows another perspective view of the permanently fixed ground attachment embodiment, without a fishing rod.

FIG. 3 shows a rear perspective view of the removably fixed ground attachment embodiment, along with an angled foot pedal for supporting an elongated rod support.

FIG. 4 shows an exploded view of the removably fixed ground attachment embodiment.

FIG. 5 shows the detail parts that encompass the present invention.

FIG. 6 shows a particular embodiment of the present invention wherein the foot pedal and a pointed elongated bar are supporting the assembly from a ground surface.

### DETAILED DESCRIPTION OF THE INVENTION

Reference is made herein to the attached drawings. Like reference numerals are used throughout the drawings to depict like or similar elements of the rod support device. For the purposes of presenting a brief and clear description of the present invention, the preferred embodiment will be discussed as used for supporting a fishing rod in a working position from a variety of support surfaces. The drawings are intended for representative purposes only and should not be considered to be limiting in any respect.

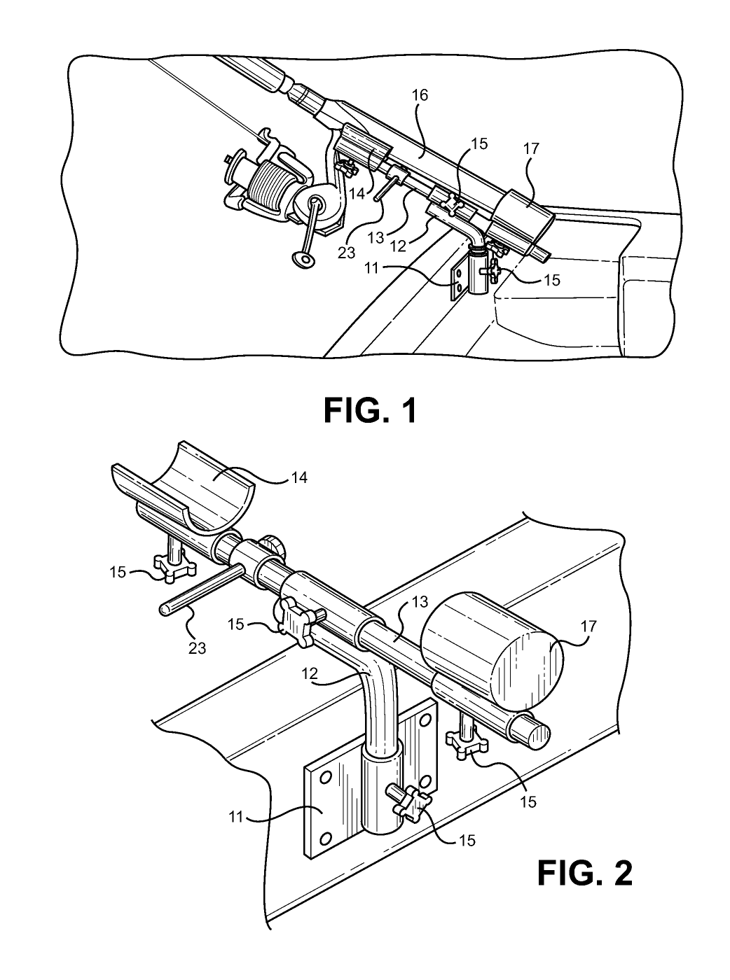

Referring now to FIG. 1, there is shown a side perspective view of the present invention in a working position. In this view, the ground support device, in the form of a side-mounted, permanently fixable pedestal mount 11, may be fastened to larger support structure for an extended period of time or for multiple uses. A cylindrical sleeve from the pedestal mount 11 is provided for communication with an angled shaft 12, which extends above the sleeve to support the remaining components of the present invention at a predetermined angle. The supported fishing rod is consequently held at this same angle during use. A cylindrical sleeve is provided on the angled shaft 12, which accepts an elongated bar 13 that runs parallel to the fishing rod. As shown in FIG. 1, a shorter bar 13 is provided to support the handle 16 of a fishing rod. At the terminal end of the elongated bar 13 is attached a U-shaped channel 14 for the rod to rest against, while the rod handle 16 butt end is supported by a handle support device 17. This device comprises a cylindrical cup-shape that accepts the butt of the handle 16 and prevents push-through and lateral movement. The components are secured together using several threaded turn-screws 15, which engage tapped holes in their respective components to allow the turn-screw 15 to drive through and bear against an adjacent component, locking the assembly together based on friction coupling provided therein. A handle 23 is provided along the elongated bar 13 for the user to grasp if necessary while reeling back a lure from the water.

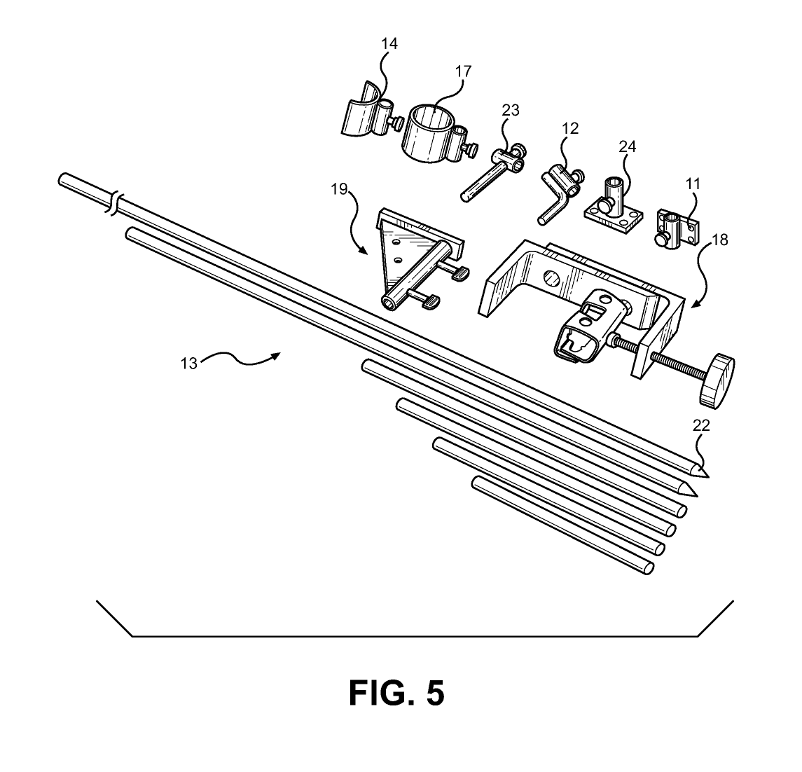

Referring now to FIG. 2, there is shown a perspective view of the present invention in a working position without a fishing rod. In this view, the components of the device are more readily apparent. The ground support device, in the form of a side-mounted pedestal mount 11, is fastened to a support structure for permanent use, while an angled shaft 12 is attached utilizing the support device 11 sleeve. A turn screw 15 provides securement of the two during use, and prevents dislocation or rotation thereof. A cylindrical sleeve attached to the angled shaft 12 provides connection to an elongated bar attachment 13, which provides stability and support for a fishing rod along its length. The length of this bar 13 is chosen to fit a particular application or length of a fishing rod. At a first end of the bar 13 is attached a fishing rod handle support device 17, which forms a cylindrical cup that supports the butt of a fishing rod. Opposite of the rod handle support device 17 is a U-shaped channel 14, which provides bearing support for the fishing rod along its length. Turn-screws are supplied for each component to secure the assembly together, while hook and loop fastened straps may be incorporated to secure the fishing rod to the elongated bar 13 and the U-shaped channel support 14. The assembly may be further supported by a vertical pedestal mount 24 (shown in FIG. 5) if mounted on a horizontal surface. Also shown is the user handle 23, which engage the elongated bar 13 and may be secured in place via a threaded turn-screw.

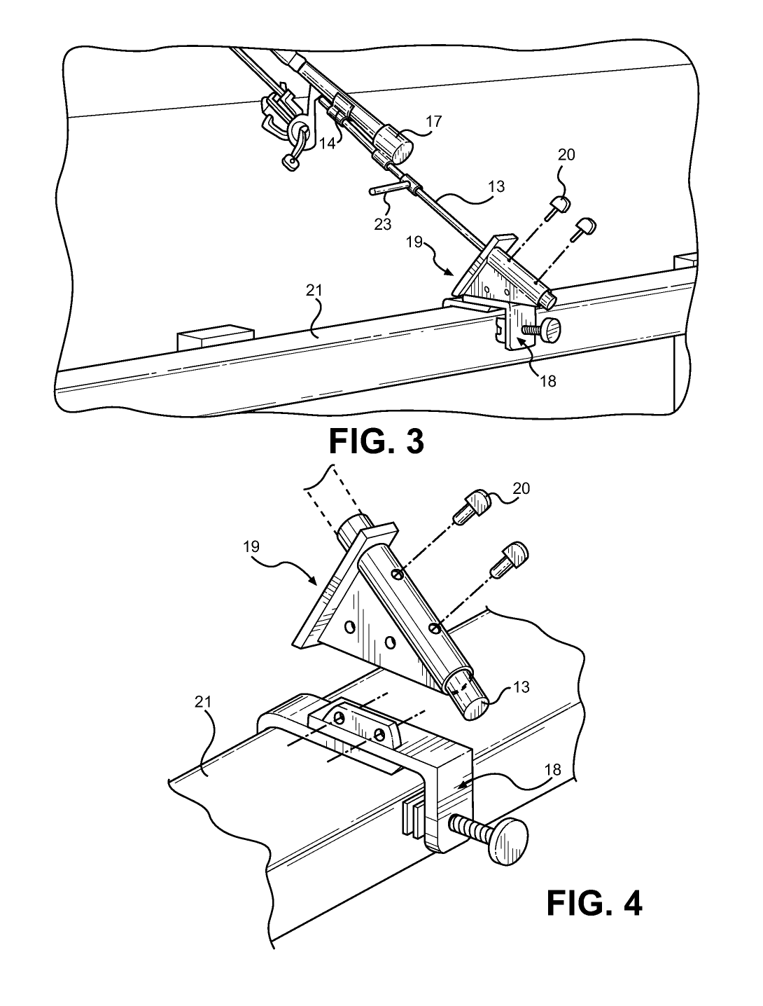

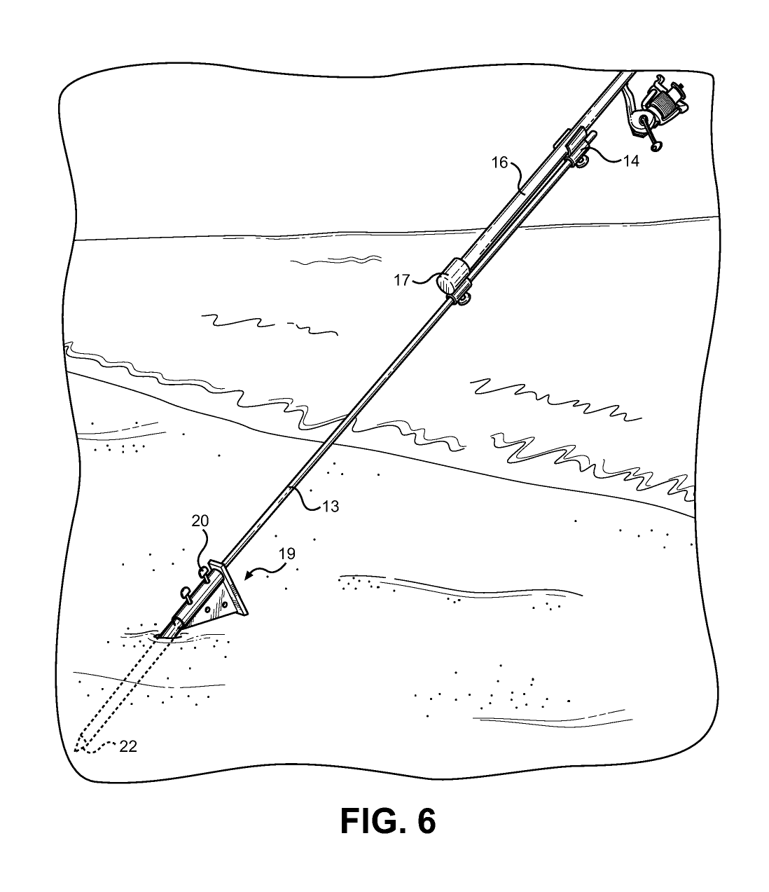

Referring now to FIG. 3, there is shown a rear perspective view of an embodiment of the present invention in its working position. In this embodiment, a clamp 18 is provided to secure the assembly and a fishing rod to a support structure 21. The clamp 18 comprises two L-brackets which form a U-channel. The distance between the upstanding walls of the U-channel is modified by a screw clamp that bears against a support structure 21 and utilizes the friction between the two to prevent dislocation of the entire assembly. Above the clamp 18 is provided a foot pedal 19, which comprises a triangular shaped structure that is designed to support a section of an elongated bar attachment 13 at a predetermined angle. The elongated bar 13 may be of any length desired, and engages a cylindrical sleeve along the upper portion of the foot pedal 19. A plurality of turn-screws are provided to secure the bar 13 to the foot pedal 19, and the foot pedal to the clamp 18. In this configuration, the rod handle support device 17 and the U-shaped channel 14 can be attached at a given distance from the foot pedal 19, depending upon the length of the elongated bar 13 and the desired height of the fishing rod. In an alternative configuration, the foot pedal 19 may be utilized as a base structure itself, without the attached clamp 18. This configuration is best suited for use when propping a fishing rod from a ground surface, such as a sandy beach or lake shore. The terminal end of the elongated bar 13, in this embodiment, may be provided with a sharpened point 22 (FIG. 5 and FIG. 6) to drive into the ground surface for further support. A handle 23 may further be provided along the elongated bar 13 for the user to grasp during fishing and reeling operations, while the assembly is secured to a base structure 21 and the fishing rod is mounted thereon.

Referring now to FIG. 4, there is shown an exploded view of an embodiment of the present invention, wherein the removably affixable clamp 18 is provided. The clamp 18 utilizes a standard clamping mechanism to press itself against opposing sides of a support structure 21. Along the top of the clamp 18 is a bracket that elevates two fastener locations from which to align corresponding fastener holes along the body of the foot pedal 19. Two fasteners or turn screws may be provided to secure the clamp 18 to the foot pedal 19 at these locations. The sleeve of the foot pedal 19 provides a conduit for the elongated bar 13 to concentrically mount, while a plurality of turn-screws 20 provide securement thereof.

Referring now to FIG. 5, there is shown an exploded view of the components of the present invention which combine to form the embodiments of the fishing rod support device. Three ground attachment devices are provided, notably the removable clamp 18 and two variations of the pedestal mount 11, 24. The first pedestal mount 11 provides attachment to a vertical support surface, while the second pedestal mount 24 provides attachment to a horizontal support surface. Two angled support devices are also provided, notably the angled shaft 12 and the foot pedal 19. The angled shaft 12 is designed to work in connection with the pedestal mounts 11, 24, while the foot pedal 19 operates with the clamp 18 or independently along a ground surface. Devices utilized to physically attach to a fishing rod include the rod handle support device 17 and the U-shaped channel 14. The rod handle support 17 is a closed, cylindrical component that prevents slide-through of the rod butt while also constraining lateral movement thereof. The U-shaped channel 14 provides bearing support further up the length of the fishing rod. Both of these devices are supported by an elongated bar 13, which may take the form of any length desirable by the user. The rod support devices 14, 17 are engaged by the attachment bar through corresponding sleeves and turn-screw fastening means. A user handle 23 is also attached via a concentrically mounted loop through which is slide the elongated bar. For the particular embodiment wherein the foot pedal 19 is utilized independently of a clamp 18, a bar 13 with a pointed terminal end 22 is utilized to penetrate through a ground surface that is supporting the assembly. Penetrating the ground surface provides structural support for the pedal 19 in this configuration, and for the extended rod while in use.

Referring now to FIG. 6, there is shown a configuration of the present invention wherein the foot pedal 19 and a pointed elongated bar 13 are utilized to secure the assembly and an associated fishing rod 16 to a ground surface. This configuration allows a fisherman to mount the device to the ground where a proper support surface is otherwise nonexistent. This is useful when fishing from a shoreline. The foot pedal 19 supports the elongated bar 13 at a predetermined angle, while the end 22 of the elongated bar is driven into the ground. The elongated bar 13 may be several feet long to support the fishing rod at an elevated position, allowing the lure to be cast farther away from shore.

In use, an individual utilizes the embodiments of the present invention to support a fishing rod in a working position without supporting the rod manually. This eliminates strenuous handling for extended periods or prolonged vigilance of the user. The flexibility of the present invention allows the device to be utilized for a plurality of situations, and provides the user with a universal mounting system. The system also provides a user with the ability to rapidly access a supported fishing rod in the event of a fishing lure strike. The design of the rod support device, namely the rod butt support and the U-shaped channel support, allow the user to quickly grasp and remove the rod from the device and begin retrieving the snagged fish. This quick access and retrieval ability is an integral part of novelty presented in the instant invention, as it provides improved response and reaction time to a strike on an extended lure.

The present invention provides an easily manufactured and transportable device, while providing the user with the ability to complete the task of supporting a fishing rod from a variety of support surfaces. Materials contemplated for the present invention may take the form of any durable, corrosion resistant material one skilled in the art of fishing may require. These include plastics, aluminum, steel, or similar material that is suitable structurally and is practical for the intended application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A modular, universal fishing rod support device, comprising:
a ground attachment device, rod support devices and an elongated bar support device;
said ground attachment device comprising a pedestal mount with a fastenable plate and a first cylindrical sleeve, an angled shaft concentrically mounted through said sleeve, said shaft having a second cylindrical sleeve;
said rod support devices comprising a rod handle support having a closed, cylindrical body adapted to accept the butt of a fishing rod, a third cylindrical sleeve attached thereto, along with a U-shaped channel connected to a fourth cylindrical sleeve;
said elongated bar support device comprising a round-bar that concentrically mounts through said second, third and fourth cylindrical sleeves;
said sleeves secured using turn-screw devices.

2) A device as in claim 1, further comprising a handle perpendicularly mounted from said elongated bar support device.

3) A device as in claim 1, further comprising hook and loop fastened straps to secure a fishing rod to said U-shaped channel and said elongated bar support device.

4) A modular, universal fishing rod support device, comprising:
a ground attachment device, rod support devices and an elongated bar support device;
said ground attachment device comprising a U-shaped clamp with an upstanding bracket and a triangular foot pedal mount attached to said bracket;
said foot pedal having a body region and a first cylindrical sleeve upper region;
said rod support devices comprising a rod handle support having a closed, cylindrical body adapted to accept the butt of a fishing rod and a second cylindrical sleeve attached thereto, along with a U-shaped channel connected to a third cylindrical sleeve;
said elongated bar support device comprising a round-bar that concentrically mounts through said first, second and third cylindrical sleeves;
said sleeves secured using turn-screw devices.

5) A device as in claim 4, further comprising a handle perpendicularly mounted from said elongated bar support device.

6) A device as in claim 4, further comprising hook and loop fastened straps to secure a fishing rod to said U-shaped channel and said elongated bar support device.

7) A modular, universal fishing rod support device, comprising:
a ground attachment device, rod support devices and an elongated bar support device;
said ground attachment device comprising a triangular foot pedal mount;
said foot pedal having a body region and a first cylindrical sleeve upper region;
said rod support devices comprising a rod handle support having a closed, cylindrical body adapted to accept the butt of a fishing rod and a second cylindrical sleeve attached thereto, along with a U-shaped channel connected to a third cylindrical sleeve;
said elongated bar support device comprising a round-bar that concentrically mounts through said first, second and third cylindrical sleeves;
said sleeves secured using turn-screw devices.

8) A device as in claim 7, wherein said elongated bar has a pointed terminal end adapted to drive into a ground support surface.

9) A device as in claim 7, further comprising a handle perpendicularly mounted from said elongated bar support device.

10) A device as in claim 7, further comprising hook and loop fastened straps to secure a fishing rod to said U-shaped channel and said elongated bar support device.
